(19) United States
(12) Patent Application Publication
(10) Pub. No.: US 2015/0288597 A1
(43) Pub. Date: Oct. 8, 2015

(54) TRAFFIC DISTRIBUTION FOR AN EDGE DEVICE

(71) Applicant: HANGZHOU H3C TECHNOLOGIES CO., LTD., Hangzhou, Zhejiang (CN)

(72) Inventors: Hai Wang, Beijing (CN); Wei Wang, Beijing (CN)

(21) Appl. No.: 14/441,078

(22) PCT Filed: Oct. 28, 2013
(86) PCT No.: PCT/CN2013/086073

§ 371 Date: May 6, 2015

(30) Foreign Application Priority Data
Nov. 16, 2012 (CN) 201210466380.9

(51) Int. Cl. H04L 12/729; H04L 12/26; H04L 29/12; H04L 12/801; H04L 12/707; H04L 12/46

(52) U.S. Cl. CPC H04L 45/125; H04L 45/24; H04L 12/4641; H04L 61/2007; H04L 47/12; H04L 43/062; H04L 43/0894

(57) ABSTRACT

An example of a method for use in a computer network is described, in which the computer network comprises a first network device and a second network device at a site, the first and second network devices connecting the site to a core of the computer network in a multi-homing configuration. The first network device collects egress traffic statistics to the core from the first network device and from the second network device, where the egress traffic statistics is collected based on a source Internet Protocol (IP) address with respect to each stream of egress traffic. The first network device monitors the egress traffic statistics, and upon detecting that the egress traffic from one of the first network device or the second network device has reached a predetermined condition, re-calculates a distribution of the egress traffic between the first network device and the second network device. The first network device then sends a notification so that the egress traffic is directed to either the first or the second network device according to the re-calculated distribution.

### BACKGROUND

Enterprise networks and data centres may be deployed as multiple sites distributed across different geographical locations, and the multiple physical sites may be interconnected. For example, the multiple physical sites may be interconnected at layer 2 by establishing layer 2 links over a core network. An example of a technique for connecting the separate physical sites may be Ethernet Virtual Interconnect (EVI), which provides a layer 2 interconnection function connecting multiple EVI sites over a core network. The core network may for example be a layer 3 network. Another example of a technique for linking remote physical sites at layer 2 is Overlay Transport Virtualisation (OTV).

At a site, there may be more than one network devices, each connected to one or more sites over the core network. The network devices at a site may include one or more edge devices (ED) connecting the site to the core network, and may also include one or more client-edge devices (CE) connecting the one or more EDs to one or more servers at the site. A site that has more than one EDs connecting it to the core network is referred to as “multi-homing”. In this case, each multi-homing ED may host the traffic for a portion of the Virtual Local Area Networks (VLANs) that belong to the site, to realize traffic sharing and a redundant link for data forwarding at the site. Here, a network device which may act as an edge device to link a site to the core network may be a router, switch, Integrated Access Device (IAD), or a variety of Metropolitan Area Network (MAN) and Wide Area Network (WAN) access devices.

### BRIEF DESCRIPTION OF THE DRAWINGS

FIG. 1 is a schematic diagram of an example configuration of a computer network;

FIG. 2 is a flow diagram of an example of a method for use by a network device in a computer network;

FIG. 3 is an example of a traffic monitoring table;

FIG. 4 is further examples of a traffic monitoring table;

FIG. 5 is a flow diagram of an example of another method for use by a network device in a computer network;

FIG. 6 is a schematic diagram of an example of a network device for use in the method of FIG. 2; and

FIG. 7 is a schematic diagram of an example of a network device for use in the method of FIG. 3.

### DETAIL DESCRIPTION

Conventionally, at a multi-homing site having two or more EDs, the distribution of VLANs amongst the EDs is performed during an initial configuration. Once the initial configuration is completed, the distribution of VLANs amongst the EDs does not change unless there are network changes that require the VLANs to be re-distributed, for instance changes in the number of active VLANs or an ED at the site joins or leaves the site. However, in practice, different VLANs may provide different services and may have different amount of data traffic.

An example of a method for use in a computer network is described. The computer network comprises a first network device and a second network device at a site, the first and second network devices connecting the site to a core of the computer network in a multi-homing configuration. The method comprises the first network device collecting egress traffic statistics to the core from the first network device and from the second network device, the egress traffic statistics being collected based on a source Internet Protocol (IP) address with respect to each stream of egress traffic. The first network device monitors the egress traffic statistics, and upon detecting that the egress traffic from one of the first network device or the second network device has reached a predetermined condition, re-calculates a distribution of the egress traffic between the first network device and the second network device, and sends a notification so that the egress traffic is directed to either the first or the second network device according to the re-calculated distribution.

According to the example, statistics of the traffic load passing through the first and second network devices are collected and monitored by the first network device on an IP address basis. When one of the first or second network device experiences heavy traffic, the situation may be detected as a result of the monitoring, and the sources of the traffic may be identified by the source IP addresses. It may therefore be possible to re-calculate the traffic distribution between the first and second network devices, and to direct the traffic according to the re-calculated distribution timely, such that a situation in which one network device is experiencing heavy traffic load while part of the bandwidth resource of another network device is sitting idle may be avoided.

In an example, the first and second network devices may be two edge devices arranged in a multi-homing configuration. In another example, the first network device may be a Software-defined Networking (SDN) controller, such as an OpenFlow controller, configured to collect egress traffic statistics from the site to the core.

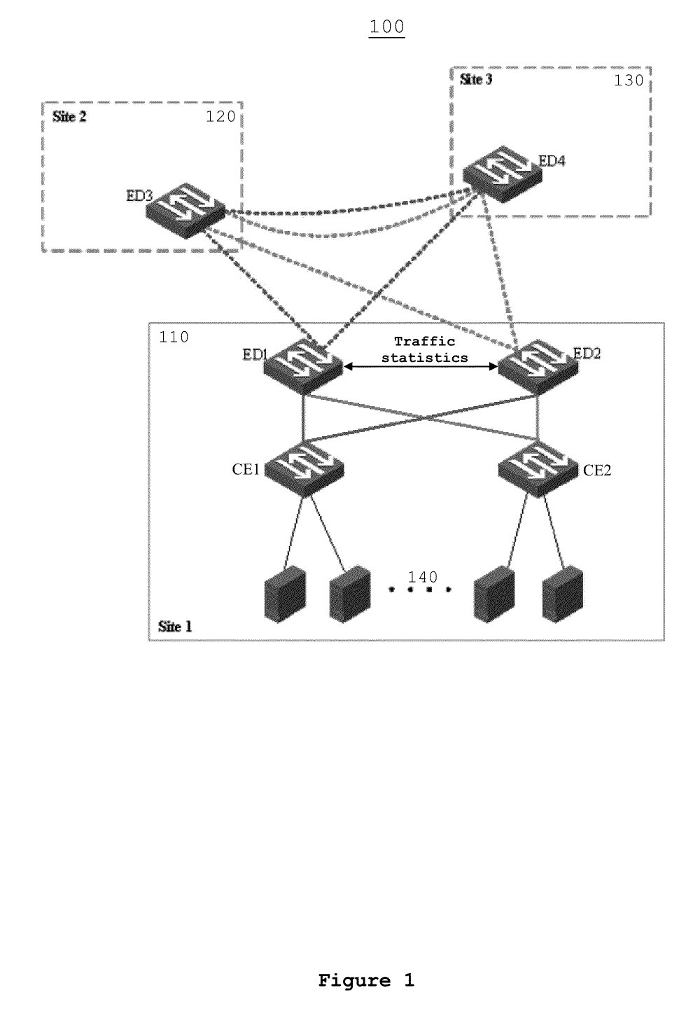

An example of a communication network deployed across multiple sites is shown schematically in FIG. 1. In the example, the network 100 comprises three sites—Site 1 110, Site 2 120 and Site 3 130. These sites may for example be EVI sites connected using an EVI technique, or OTV sites connected using an OTV technique. More or fewer sites may be deployed as required. At the edge of Site 1 are two edge devices ED1 (first edge device) and ED2 (second edge device), which together connect Site 1 to Site 2 and Site 3 via edge devices ED3 and ED4 respectively over a core network. At Site 1, each of the edge devices ED1 and ED2 is respectively connected to client-edge switches CE1 and CE2, which in turn are connected to a plurality of nodes 140. The nodes 140 may include a network device such as a modem, a hub, a network bridge or a switch, or a device such as a digital telephone handset, a personal computer or a host computer, which may be a router, a workstation or a server. Although switches CE1 and CE2 are provided between the edge devices ED1 and ED2 and the nodes 140 in the present example, the edge devices ED1 and ED2 may alternatively be connected directly to the plurality of nodes 140 in other examples.

In the example, the multi-homing edge devices ED1 and ED2 at Site 1 may communicate with each other and with the client-edge switches CE1 and CE2 using a link state protocol, such as an IS-IS protocol. For example, by sending IS-IS Hello messages, the edge devices ED1 and ED2 may elect a designated edge device to perform the function of collecting and monitoring egress traffic statistics of Site 1 and allocating the egress traffic to one of the edge devices ED1 and ED2. The example thus enables traffic load sharing by dynamically and flexibly dividing traffic between the edge devices on an IP address basis. Although only two edge devices are provided to the Site 1 in the example, more than two edge devices may be provided to a site as required.

In the following example, assume that during an initial system configuration, at a site having a first edge device ED1 and a second edge device ED2 in a multi-homing configuration, ED1 is elected as a designated edge device, and egress traffic from the site to the core is distributed between ED1 and ED2, for example by allocating streams having a source IP address ending in an even number to ED1 and streams having a source IP address ending in an odd number to ED2, or allocating streams belonging to the first half of a list of IP addresses to ED1 and the second half to ED2. In the present example, assume that there are six source IP addresses from the site and the first three IP addresses are allocated to ED1, while the remaining three IP addresses are allocated to ED2.

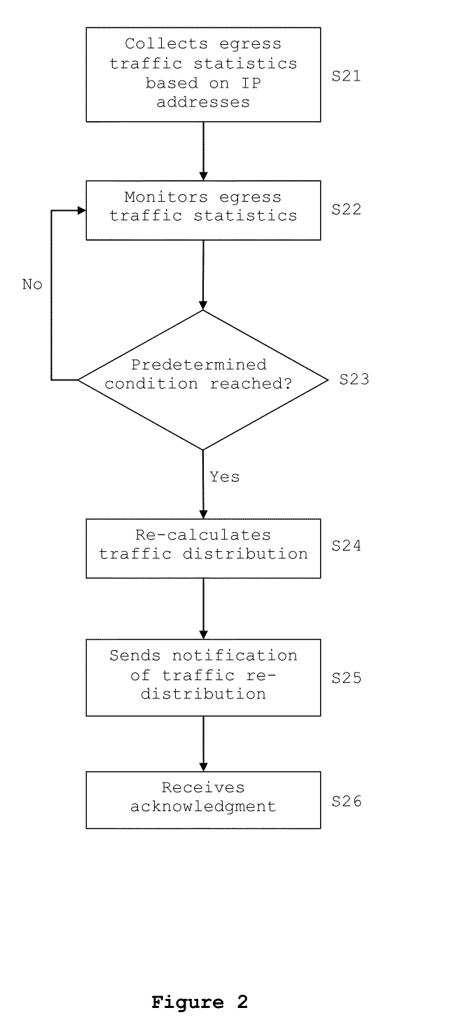

An example of a method that may be implemented by an edge device such as the edge device ED1 at a site described above is illustrated in FIG. 2.

At block S21, ED1 collects egress traffic statistics from the site to the core from both ED1 and ED2. The egress traffic statistics are collected based on the source IP address of each stream of the egress traffic.

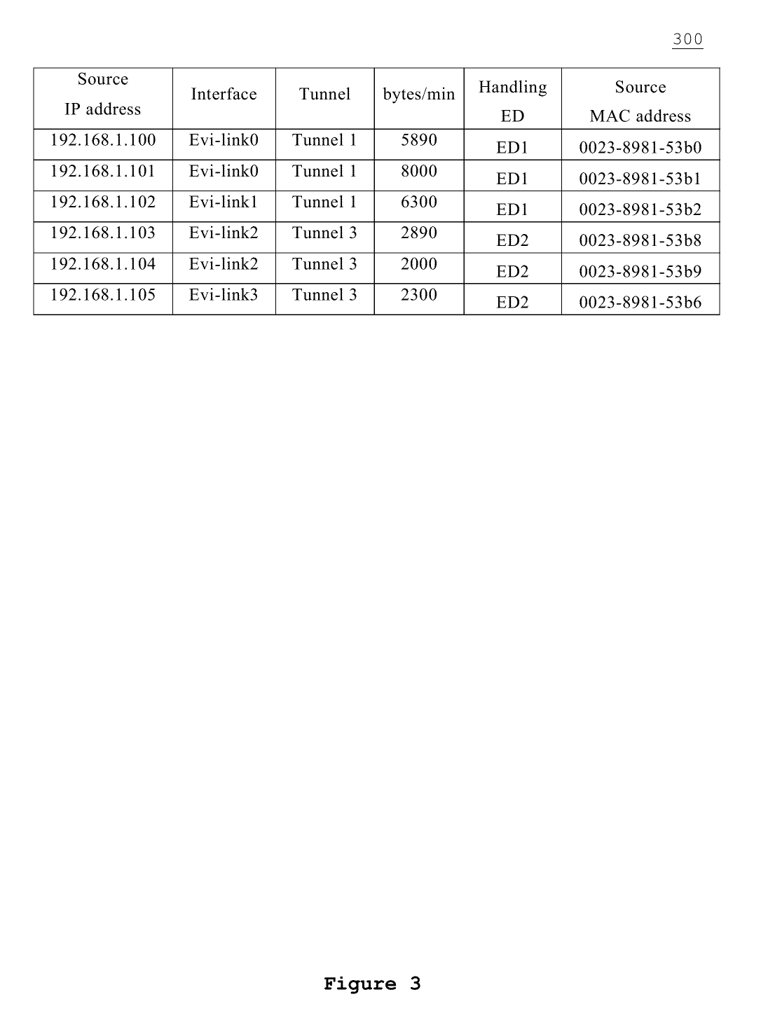

In particular, ED1 may for example enable a traffic statistics function to create a traffic monitoring table, and record traffic statistics with respect to the source IP addresses of each stream. An example of such a traffic monitoring table is shown in FIG. 3. With reference to table 300, ED1 may record the bandwidth consumption (e.g. in bytes/min) of each stream with respect to the source IP address of the stream, and in addition determine the corresponding MAC address of the source IP address, for example from a conversion table such as an Address Resolution Protocol (ARP) table, the interface that connects a client from the particular MAC address to ED1, and the tunnel (e.g. a Generic Routing Encapsulation GRE tunnel) used by the particular stream. As can be seen from table 300, clients with source MAC addresses 0023-8981-53b0, 0023-8981-53b0 and 0023-8981-53b2 access the core network via the edge device ED1, and the egress traffic from each of the MAC addresses may be monitored by ED1 using the table 300.

ED2 may similarly enable a traffic statistic function to create a traffic monitoring table for all its egress traffic, as described above with reference to ED1. ED2 may create a traffic monitoring table that is separate from the traffic monitoring table 300 created by ED1. ED1 may obtain the egress traffic statistics of ED2 by, for example, communicating with ED2 through exchanging Hello messages. In an example, a Hello message exchanged between ED1 and ED2 may be an IS-IS Hello message with an additional CLV (Code-Length-Value), as shown below:

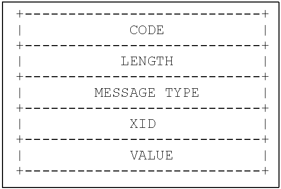

The “CODE” field is used for indicating the type of field that this part of the Hello message represents. The “LENGTH” field indicates the length of the CLV. The “MESSAGE TYPE” field indicates the type of the message, which may be a request message or a response message: For example, “1” may indicate a request message for requesting traffic statistics information; “2” a response message for acknowledging reception of traffic statistics information; “3” a request message for requesting adjustment of traffic; and “4” a response message for acknowledging reception of a traffic adjustment request. The “XID” field is an arbitrary value selected for a traffic request used for identifying the traffic request. The “VALUE” field contains information to be communicated, such that when the “MESSAGE TYPE” is 2, the “VALUE” is the requested traffic statistics information, when the “MESSAGE TYPE” is 3, the “VALUE” is the allocation result of the traffic adjustment, and when the “MESSAGE TYPE” is 1 or 4, the “VALUE” is empty or set to a default value.

In the example, by exchanging Hello messages of “MESSAGE TYPE” 1 and 2, ED1 and ED2 may communicate egress traffic statistics information, and ED1 may collect egress traffic statistics for all egress traffic at the site.

At block S22, ED1 monitors all egress traffic statistics at the site, for example by creating the traffic monitoring table 300.

At block S23, ED1 checks whether a predetermined condition is reached by either ED1 or ED2. If the predetermined condition is not reached, ED1 continues to monitor the egress traffic statistics.

In an example, ED1 may use the information collected in table 300 to check if the predetermined condition is reached. The checking may involves ED1 calculating the difference between the total bandwidth consumption of all traffic from ED1 and the total bandwidth consumption of all traffic from ED2. For example, the difference in bandwidth consumption between ED1 and ED2 is (5890+8000+6300)−(2890+2000+2300)=13000 bytes/min. A predetermined threshold may be set for the difference such that when the difference is above the predetermined threshold, ED1 determines that the predetermined condition is reached. As an example, a predetermined threshold is set at 3000 bytes/min, and so, in this case, the predetermined condition is reached. If the site has more than two edge devices, the difference in bandwidth consumption may be determined between all possible pair of edge devices, and it may be configured such that the predetermined condition is reached if the difference between any pair exceeds the predetermined threshold.

Upon detecting that the egress traffic from ED1 and ED2 has reached the predetermined condition, ED1 re-calculates the distribution of the egress traffic between ED1 and ED2 at block S24. Various redistribution methods and combinations thereof may be used depending on system requirements and preferences.

As an example, ED1 may calculate an average value per edge device at the site for the total bandwidth consumption of the site. Using the example of table 320, the total bandwidth consumption of the site is (5890+8000+6300+2890+2000+2300)=27380 bytes/min, the number of edge devices at the site is 2, thus the average value is 13690 bytes/min. If the site has more than two edge devices, the average value may be determined between a pair of edge devices that has reached the predetermined condition.

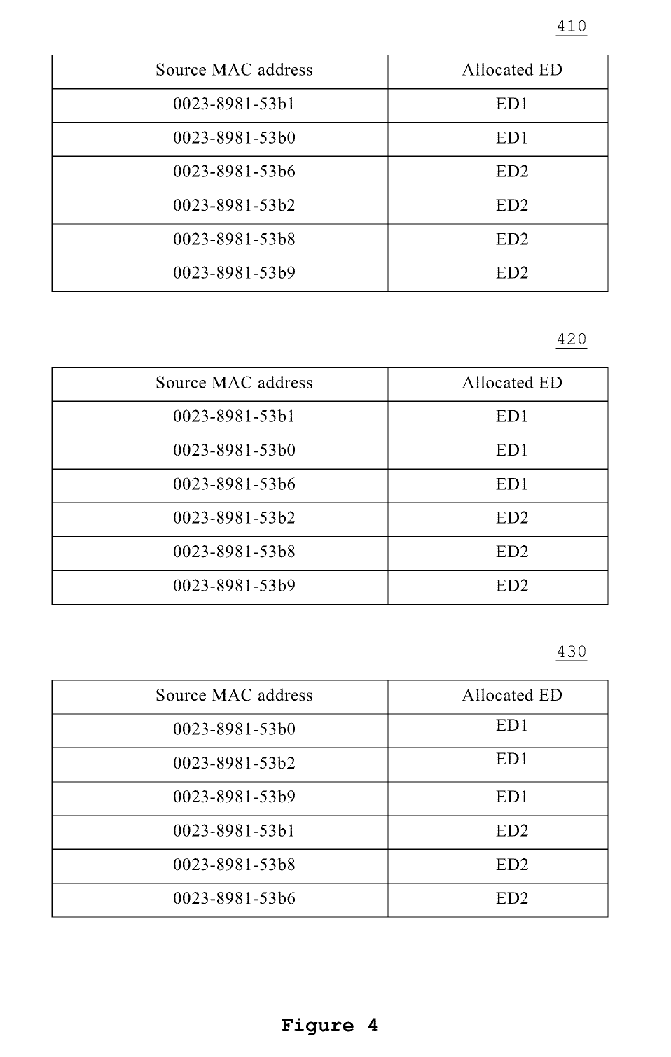

In the present example, ED1 has a total bandwidth consumption that is above the average value. ED1 may be configured to select one or more streams from its traffic to form a first group until the total bandwidth consumption of the first group reaches the average value. Since the source MAC address of each stream corresponds to the physical address of the stream, the selection may be performed on the basis of the source MAC address of each stream. In this example, ED1 may select MAC addresses 0023-8981-53b0 and 0023-8981-53b1 as the first group, in which case the total bandwidth consumption of the first group is 5890+8000=13890 bytes/min, just above the average value of 13690 bytes/min. The remaining traffic (MAC addresses), in this example the MAC address 0023-8981-53b2, may be selected as a second group, which will be diverted to ED2. The redistribution is illustrated by table 410 in FIG. 4.

As another example of a redistribution method, ED1 may be configured to select one of its traffic streams at random, and switch the selected stream with a randomly selected one of the traffic streams from ED2. For example, ED1 may select the stream with the MAC address 0023-8981-53b2 from its traffic, and switch it with the stream with the MAC address 0023-8981-53b6 from the traffic of ED2. The redistribution is illustrated by table 420.

As yet another example of a redistribution method, ED1 may be configured to sort all traffic from ED1 and ED2 in an order according to MAC addresses, and select the traffic from every other MAC addresses as a first group. In particular, ED1 may select traffic from every other MAC addresses from the traffic monitoring table 320 as the first group. The remaining MAC addresses may be selected as a second group. The first group may be allocated to ED1 while the second group may be allocated to ED2, as illustrated by table 430.

Once the new egress traffic distribution has been calculated, at block S25, ED1 sends a notification to the one or more client-edge devices that are connected to ED1 and ED2, for example CE1 and CE2, notifying them of the traffic redistribution. The notification from ED1 to CE1 and CE2 may be a Hello message of “MESSAGE TYPE” 3.

CE1 and CE2, after receiving the notification from ED1, reconfigure their output interfaces such that output interfaces corresponding to the MAC addresses as shown in tables 410, 420 or 430 designate the allocated edge device as the output edge device according to the allocation in the table. CE1 and CE2 then send an acknowledgement to ED1 notifying ED1 that the traffic redistribution notification has been received. The acknowledgement from CE1 and CE2 to ED1 may for example be a Hello message of “MESSAGE TYPE” 4.

At block S26, ED1 receives the acknowledgment from CE1 and CE2 and determines that the traffic redistribution has complete.

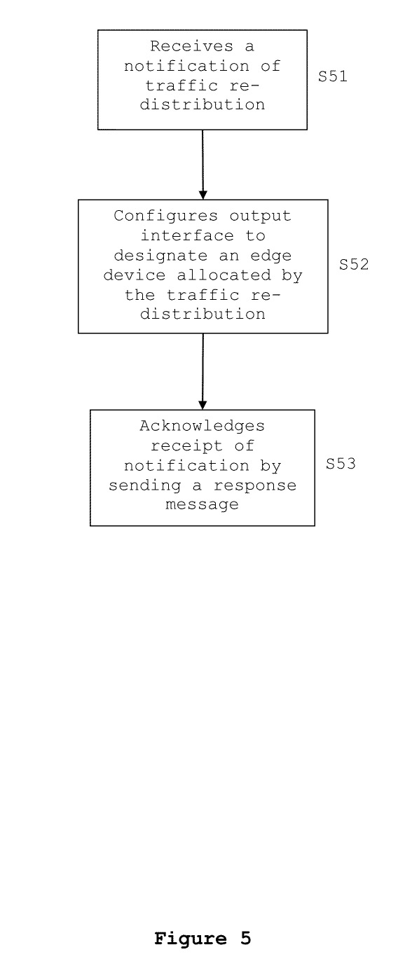

FIG. 5 illustrates an example of a traffic redistribution method that may be implemented in conjunction with the method of FIG. 2, by a network device such as the client-edge device CE1.

At block S51, CE1 receives a notification of traffic redistribution from ED1. The notification from ED1 may be a Hello message of “MESSAGE TYPE” 3 containing information such as one of the tables 410, 420 or 430. The information may be placed in the value field of the Hello message for example.

At block S52, CE1 configures its forwarding table in accordance with the received traffic redistribution information. For example, CE1 may configure the entries in its forwarding table that correspond to the MAC addresses as shown in one of the tables 410, 420 or 430 to designate the allocated ED as the output ED according to the tables 410, 420 or 430. Thereafter, an output interface of CE1 directs traffic originating from the each MAC address to the allocated ED.

At block S53, CE1 acknowledges receipt of the traffic redistribution information by sending a response message. The response message from CE1 to ED1 may for example be a Hello message of “MESSAGE TYPE” 4.

Although the examples above have been described with respect to one of a plurality of edge devices in a multi-homing configuration collecting egress traffic statistics and re-calculating a distribution of egress traffic, a person skilled in the art would appreciate that the methods described above may equally be implemented by a Software-defined Networking (SDN) controller, such as an OpenFlow controller. Thus, in a configuration of SDN, where logical network control plane hardware is physically decoupled from data forwarding plane hardware, a network device such as a server or the like may acts as a SDN controller that collects egress traffic statistics and re-calculating a distribution of egress traffic, and instructs a SDN switch to reconfigure its forwarding table according to the re-calculated distribution.

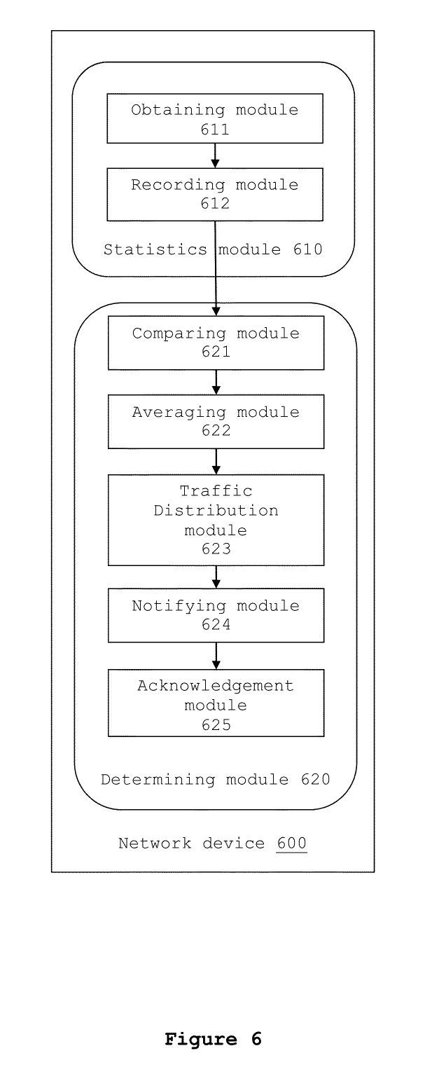

An example of a network device that may function as an edge device such as the edge device ED1 is shown in FIG. 6. The network device 600 comprises a statistics module 610 and a determining module 620.

The statistics module 610 is configured to collect egress traffic statistics to the core from the edge devices of the site, in this example ED1 and ED2. The egress traffic statistics may be collected by enabling a traffic statistics function and creating a traffic monitoring table as described in the example method above.

The determining module 620 is configured to monitor the egress traffic statistics. Upon detection of the egress traffic from either ED1 or ED2 reaching a predetermined condition, the determining module 620 re-calculates a distribution of the egress traffic between ED1 and ED2, and sends a notification for the egress traffic to be directed to either ED1 or ED2 according to the re-calculated distribution.

In an example, the statistics module 610 may further comprise an obtaining module 611 configured to obtain the bandwidth consumption for each stream of egress traffic handled by each of the edge devices ED1 and ED2 with respect to the source IP address of each stream.

In the example, the statistics module may further comprise a recording module 612 configured to record the bandwidth consumption with respect to each of a plurality of source MAC addresses, the source MAC addresses being the physical locations from which egress traffic handled by ED1 originate. The recording module 612 record the bandwidth consumption with respect to the source MAC addresses by obtaining, for each stream of egress traffic handled by ED1, the bandwidth consumption with respect to the source IP address of the stream, and obtaining a source MAC address that corresponds to the source IP address using a conversion table. The conversion table may be an ARP table. The obtaining module 612 is configured to obtain from ED2 the bandwidth consumption with respect to each of a plurality of source MAC addresses from which egress traffic is handled by ED2.

In an example, the determining module 620 may be configured to allocate a stream of egress traffic to ED1 or ED2 based on the bandwidth consumption with respect to the source IP address of the stream when the egress traffic from ED1 or ED2 has reached the predetermined condition. The determining module 620 may then send a notification to one or more client-edge devices at the site to cause the client-edge device to configure an output interface that corresponds to the source IP address to designate the allocated edge device as the output edge device.

In an example, the determining module 620 may further comprise a comparing module 621 configured to obtain the difference between the total bandwidth consumption for each stream of egress traffic handled by ED1, and the total bandwidth consumption for each stream of egress traffic handled by ED2, and compare the difference with a predetermined threshold. The determining module 620 may determine that the predetermined condition is reached when the difference is above the predetermined threshold.

In an example, the determining module 620 may further comprise an averaging module 622 configured to determine an average bandwidth consumption, by summing the total bandwidth consumption for each stream of egress traffic handled by ED1 and the total bandwidth consumption for each stream of egress traffic handled by ED2, and dividing the sum by 2. The determining module 620 may also comprise a traffic distribution module 623 configured to select, from amongst the egress traffic handled by the edge device with the higher load between ED1 and ED2, that is an edge device with a total bandwidth consumption above the average bandwidth consumption (e.g. ED1), at least one stream of egress traffic, and to allocate the selected stream to the higher-load edge device. The selection may for example be as illustrated in table 410. The determining module 620 may also comprise a notifying module 624 configured to send a notification to the one or more client-edge devices at the site, such as the client-edge devices CE1 and CE2, the notification containing the allocation of the selected stream.

In an example, the traffic distribution module 623 may be configured to select as a first group, from amongst the egress traffic handled by the edge device with the higher load between ED1 and ED2, that is an edge device with a total bandwidth consumption above the determined average bandwidth consumption (e.g. ED1), one or more streams of egress traffic until the total bandwidth consumption of the first group reaches (equals to or is higher than) the determined average bandwidth consumption. The selection may be performed by arranging the traffic from ED1 by their source MAC addresses in an order from high to low bandwidth consumption, and selecting a MAC address with the highest bandwidth consumption first until the bandwidth consumption of the first group reaches the average value. The traffic distribution module may then allocate the first group to the higher-load edge device, ED1, select the remaining one or more streams of egress traffic that are not selected as the first group as a second group, and allocate the second group to ED2.

In an example, the determining module 620 may further comprise an acknowledgement module 625 configured to receive acknowledgements from the client-edge devices, which are sent by the client-edge devices in response to receiving a traffic redistribution notification.

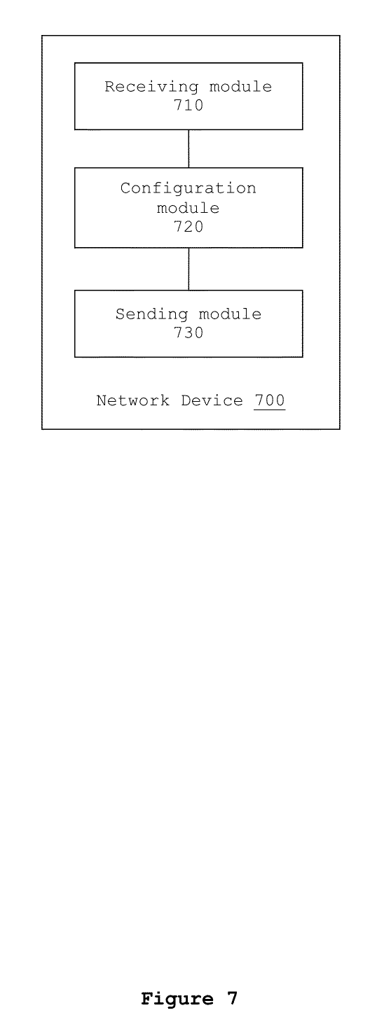

An example of a network device that may function as a client-edge device such as the client-edge device CE1 is shown in FIG. 7. The network device 700 comprises a receiving module 710, a configuration module 720 and a sending module 730.

In the example, the receiving module 710 receives a notification from a designated edge device at the site such as the edge device ED1. The configuration module 720 configures a forwarding table of CE1 to designate the allocated edge device as the output edge device, so as to cause an output interface of CE1 to direct traffic to the allocated edge device, based on traffic redistribution information contained in the received notification. The sending module 730 sends an acknowledgement to ED1 in response to receiving a notification from ED1.

Although the flow diagram described above show a specific order of execution, the order of execution may differ from that which is depicted.

The above examples can be implemented by hardware, software, firmware, or a combination thereof. For example, the various methods and functional modules described herein may be implemented by a processor (the term processor is to be interpreted broadly to include a CPU, processing unit, ASIC, logic unit, or programmable gate array etc.). The methods and functional modules may all be performed by a single processor or divided amongst several processors. The methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the method and devices described above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method for a computer network comprising a first network device and a second network device at a site, the first and second network devices connecting the site to a core of the computer network in a multi-homing configuration, the method comprising the first network device:
collecting egress traffic statistics to the core from the first network device and from the second network device, the egress traffic statistics being collected based on a source Internet Protocol IP address with respect to each stream of egress traffic; and
monitoring the egress traffic statistics, upon detecting that the egress traffic from one of the first network device or the second network device has reached a predetermined condition, re-calculating a distribution of the egress traffic between the first network device and the second network device, and sending a notification for the egress traffic to be directed to either the first or the second network device according to the re-calculated distribution.

2. The method of claim 1 wherein the collecting egress traffic statistics comprises the first network device obtaining a bandwidth consumption for each stream of egress traffic handled by each of the first and second network devices, with respect to the source IP address of each stream.

3. The method of claim 1 wherein the collecting egress traffic statistics comprises the first network device:
recording a bandwidth consumption with respect to each of a plurality of source Media Access Control MAC addresses from which egress traffic is handled by the first network device, by obtaining, for each stream of egress traffic handled by the first network device, a bandwidth consumption with respect to the source IP address of the stream and obtaining a source MAC address corresponding to the source IP address using a conversion table; and
obtaining from the second network device a bandwidth consumption with respect to each of a plurality of source MAC addresses from which egress traffic is handled by the second network device.

4. The method of claim 2 wherein the sending a notification comprises the first network device allocating a stream of egress traffic to either the first network device or the second network device based on the bandwidth consumption with respect to the source IP address of the stream, and sending a notification to at least one client-edge device at the site to cause an output interface of the client-edge device, which corresponds to the source IP address, to designate the allocated network device.

5. The method of claim 2 wherein the predetermined condition is reached when a difference between a total of the bandwidth consumption for each stream of egress traffic handled by the first network device and a total of the bandwidth consumption for each stream of egress traffic handled by the second network device is above a predetermined threshold.

6. The method of claim 2 wherein the re-calculating a distribution of the egress traffic comprises the first network device:
determining an average bandwidth consumption by summing a total of the bandwidth consumption for each stream of egress traffic handled by the first network device and a total of the bandwidth consumption for each stream of egress traffic handled by the second network device, and dividing the sum by 2; and
selecting, from amongst the egress traffic handled by a higher-load network device that is one of the first or second network device having a total bandwidth consumption above the determined average bandwidth consumption, at least one stream of egress traffic and allocating the selected stream to the higher-load network device.

7. The method of claim 2 wherein the re-calculating a distribution of the egress traffic comprises the first network device:
determining an average bandwidth consumption by summing a total of the bandwidth consumption for each stream of egress traffic handled by the first network device and a total of the bandwidth consumption for each stream of egress traffic handled by the second network device, and dividing the sum by 2;
selecting as a first group, from amongst the egress traffic handled by a higher-load network device that is one of the first or second network device that has a total bandwidth consumption above the determined average bandwidth consumption, one or more streams of egress traffic in an order from high to low bandwidth consumption until a total bandwidth consumption of the first group is equalled to or higher than the determined average bandwidth consumption, and allocating the first group to the higher-load network device; and
selecting the remaining one or more streams of egress traffic that are not selected as the first group as a second group, and allocating the second group to the other one of the first or second network device that is not the higher-load network device.

8. A network device for use in a computer network, the computer network comprises the network device and another network device at a site, the network device and the another network device connecting the site to a core of the computer network in a multi-homing configuration, the network device comprising:
a statistics module to collect egress traffic statistics to the core from the network device and from the another network device, the egress traffic statistics being collected based on a source Internet Protocol IP address with respect to each stream of egress traffic; and
a determining module to monitor the egress traffic statistics, upon detection of the egress traffic from either the network device or the another network device having reached a predetermined condition, to re-calculate a distribution of the egress traffic between the network device and the another network device, and to send a notification for the egress traffic to be directed to either the first or the second network device according to the re-calculated distribution.

9. The network device of claim 8 wherein the statistics module further comprises an obtaining module to obtain a bandwidth consumption for each stream of egress traffic handled by each of the network device and the another network device, with respect to the source IP address of each stream.

10. The network device of claim 8 wherein the statistics module further comprises:
a recording module to record a bandwidth consumption with respect to each of a plurality of source Media Access Control MAC addresses from which egress traffic is handled by the network device, by obtaining, for each stream of egress traffic handled by the network device, a bandwidth consumption with respect to the source IP address of the stream and obtaining a source MAC address corresponding to the source IP address using a conversion table; and
an obtaining module to obtain from the another network device a bandwidth consumption with respect to each of a plurality of source MAC addresses from which egress traffic is handled by the another network device.

11. The network device of claim 9 wherein the determining module is to allocate a stream of egress traffic to the network device or the another network device based on the bandwidth consumption with respect to the source IP address of the stream when the egress traffic from either the network device or the another network device has reached the predetermined condition, and to send a notification to at least one client-edge device at the site to cause an output interface of the client-edge device, which corresponds to the source IP address, to designate the allocated network device.

12. The network device of claim 9 wherein the determining module further comprises a comparing module to compare a difference between a total of the bandwidth consumption for each stream of egress traffic handled by the network device and a total of the bandwidth consumption for each stream of egress traffic handled by the another network device with a predetermined threshold, and the determining module is to determine that the predetermined condition is reached when the difference is above the predetermined threshold.

13. The network device of claim 9 wherein the determining module further comprises:
an averaging module to determine an average bandwidth consumption by summing a total of the bandwidth consumption for each stream of egress traffic handled by the network device and a total of the bandwidth consumption for each stream of egress traffic handled by the another network device, and dividing the sum by 2; and
a traffic distribution module to select, from amongst the egress traffic handled by a higher-load network device that is one of the network device or the another network device having a total bandwidth consumption above the determined average bandwidth consumption, at least one stream of egress traffic, and to allocate the selected stream to the higher-load network device; and
a notifying module to send a notification to at least one client-edge device at the site containing the allocation of the selected stream.

14. The network device of claim 9 wherein the determining module further comprises:
an averaging module to determine an average bandwidth consumption by summing a total of the bandwidth consumption for each stream of egress traffic handled by the network device and a total of the bandwidth consumption for each stream of egress traffic handled by the another network device, and dividing the sum by 2;
a traffic distribution module to select as a first group, from amongst the egress traffic handled by a higher-load network device that is one of the network device or the another network device having a total bandwidth consumption above the determined average bandwidth consumption, one or more streams of egress traffic in an order from high to low bandwidth consumption until a total bandwidth consumption of the first group is equalled to or higher than the determined average bandwidth consumption, to allocate the first group to the higher-load network device, to select the remaining one or more streams of egress traffic that are not selected as the first group as a second group, and to allocate the second group to the other one of the network device or the another network device that is not the higher-load network device; and
a notifying module to send a notification to at least one client-edge device at the site containing the allocation of the selected stream.

15. The method of claim 1 or the network device of claim 8 wherein the network devices are edge devices.
